(19) United States
(12) Patent Application Publication
(10) Pub. No.: US 2026/0126994 A1
(43) Pub. Date: May 7, 2026

(54) GENERATING SOFTWARE FUNCTIONALITY DESCRIPTIONS USING GENERATIVE MACHINE LEARNING MODELS

(71) Applicant: International Business Machines Corporation, Armonk, NY (US)

(72) Inventors: Kun Yan Yin, Ningbo (CN); Jing Zhang, Shanghai (CN); Yuan Yuan Ding, Shanghai (CN); Shi Yun Liang, Shanghai (CN); Mehdi Charafeddine, Vaud (CH); Anthony Giordano, Detroit, MI (US); Yu Pan, Shanghai (CN)

(21) Appl. No.: 18/938,902

(22) Filed: Nov. 6, 2024

(51) Int. Cl. G06F 8/74

(52) U.S. Cl. CPC G06F 8/74

(57) ABSTRACT

A computer-implemented method includes identifying development-related information within at least one functional architecture associated with a given item of software; generating at least one knowledge graph representing at least a portion of the development-related information; generating at least one prompt based at least in part on one or more portions of the at least one knowledge graph; generating one or more software functionality descriptions for at least a portion of the given item of software by processing the at least one prompt using at least one generative machine learning model; and performing one or more automated actions based at least in part on the one or more software functionality descriptions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present application generally relates to information technology, to software development, to generative machine learning models, to artificial intelligence agents that interact with generative machine learning models, and to utilizing resources of generative machine learning models to assist with software development tasks.

### SUMMARY

In at least one embodiment, an example computer-implemented method can include identifying development-related information within at least one functional architecture associated with a given item of software, and generating at least one knowledge graph representing at least a portion of the development-related information. The method also includes generating at least one prompt based at least in part on one or more portions of the at least one knowledge graph, and generating one or more software functionality descriptions for at least a portion of the given item of software by processing the at least one prompt using at least one generative machine learning model. Further, the method includes performing one or more automated actions based at least in part on the one or more software functionality descriptions.

Another embodiment of the invention or elements thereof can be implemented in the form of a computer program product tangibly embodying computer-readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating example system architecture for automatically generating software functionality descriptions, according to an example embodiment of the invention;

FIG. 2 is a diagram illustrating an example architecture graph parser workflow, according to an example embodiment of the invention;

FIG. 3 is a diagram illustrating an example workflow for aligning different entity descriptions, according to an example embodiment of the invention;

FIG. 4 is a diagram illustrating an example workflow for generating a user story, according to an example embodiment of the invention;

FIG. 5 shows example pseudocode for generating a user story prompt template in an illustrative embodiment;

FIG. 6 is a flow diagram illustrating techniques according to an example embodiment of the invention; and

FIG. 7 is a diagram illustrating a computing environment in which at least one embodiment of the invention can be implemented.

### DETAILED DESCRIPTION

As described herein, at least one embodiment includes automatically generating software functionality descriptions (also referred to herein as user stories) based at least in part on one or more functional architecture graph and requirements using at least one generative machine learning model (e.g., at least one large language model (LLM)). As used herein, a user story generally refers to a description of software functionality used in software development, wherein such a description can include a focusing on, for example, one or more user needs, one or more values, etc. More specifically, descriptions of software functionality used in software development can help development teams better understand and meet user needs. However, in many conventional software development approaches, such descriptions are often limited to individual portions of the given software and lack relevant knowledge of comprehensive system architecture, thus leading to inaccurate and/or error-prone descriptions and resultant software outputs.

According to an aspect of the invention, there is provided a computer system, a computer program product, and a computer-implemented method for performing operations including identifying development-related information within at least one functional architecture associated with a given item of software, generating at least one knowledge graph representing at least a portion of the development-related information, generating at least one prompt based at least in part on one or more portions of the at least one knowledge graph, generating one or more software functionality descriptions for at least a portion of the given item of software by processing the at least one prompt using at least one generative machine learning model, and performing one or more automated actions based at least in part on the one or more software functionality descriptions. Such operations cause improved software development speed and enhanced efficiency of resource requirements associated with software development.

In embodiments, identifying development-related information within at least one functional architecture associated with a given item of software includes parsing information pertaining to one or more elements and one or more relationships within the at least one functional architecture. Such operations cause increased accuracy in developing corresponding software features. Additionally or alternatively, in embodiments, identifying development-related information within at least one functional architecture associated with a given item of software includes processing one or more extensible markup language files associated with the at least one functional architecture and/or processing one or more image features associated with the at least one functional architecture. Such operations lead to more comprehensive outputs with respect to corresponding software development tasks.

Also, in embodiments, performing one or more automated actions includes automatically initiating one or more software development tasks for the given item of software based at least in part on the one or more software functionality descriptions. Such operations enable automated system action and preclude error-prone manual efforts with respect to software development. Additionally or alternatively, in embodiments, performing one or more automated actions includes automatically training at least a portion of the at least one generative machine learning model using feedback related to the one or more software functionality descriptions. Such operations create a more specialized and precise generative machine learning model. Also, in embodiments, performing one or more automated actions includes automatically transmitting the one or more software functionality descriptions to one or more of at least one software-development-related system and one or more software-development-related users. Such operations cause improved efficiency and speed of delivering software development outputs.

Further, in embodiments, generating at least one knowledge graph includes aligning two or more different descriptions of the at least a portion of the development-related information. Such operations cause a more robust and accurate software development result. Additionally, in embodiments, generating at least one prompt includes generating, based at least in part on the one or more portions of the at least one knowledge graph, one or more software-development-related requirements, one or more instructions for generating the one or more software functionality descriptions, and one or more formatting instructions. Such operations cause improved accuracy and system compatibility of software development outputs. Also, in embodiments, generating one or more software functionality descriptions for at least a portion of the given item of software includes generating a first software functionality description, processing feedback related to the first software functionality description from at least one artificial intelligence agent, and generating a second software functionality description by modifying at least a portion of the first software functionality description based at least in part on one or more portions of the feedback. Such operations enable automated customization of software development tasks, reducing processing latencies and related resource requirements.

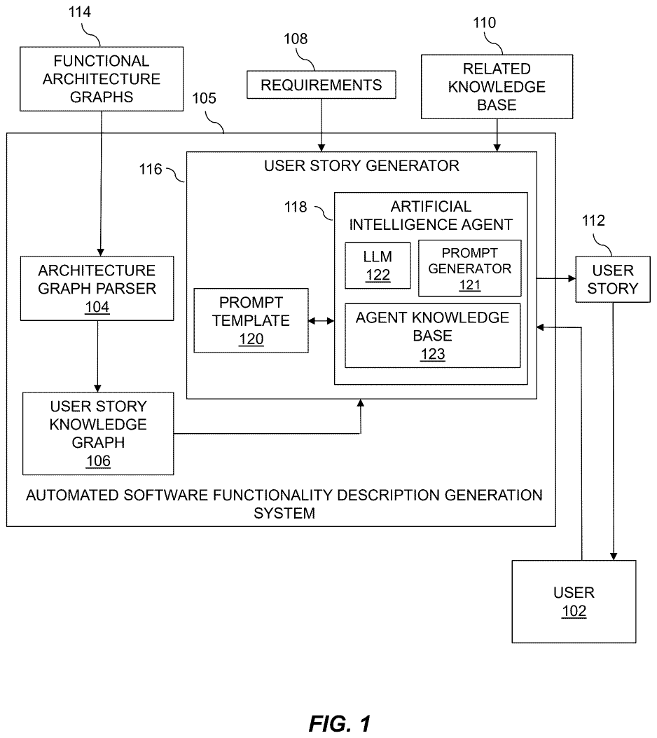

One or more embodiments include using at least one LLM to process an overall architecture diagram and one or more subsystem architecture diagrams of the given software development task, along with development system input (e.g., input from at least one data engineer), to automatically generate at least one user story for the given software development task. As further detailed herein, (e.g., in connection with FIG. 1), such an embodiment includes implementing at least one architecture graph parser for parsing elements and relationships within the functional architecture of given software based at least in part on input such as, for example, original extensible markup language (XML) and image features. In such an embodiment, the at least one architecture graph parser generates and/or outputs at least one knowledge graph which represents the functional architecture elements and relationships of the given software. In at least one embodiment, elements and relationships represent the nodes and edges, respectfully, in an architecture graph. For example, elements can include items such as, e.g., applications, real-time ingestions, etc., and relationships can include items such as, e.g., a feed relationship between two nodes in an architecture diagram.

Also, such an embodiment can include implementing at least one user story generator for generating one or more user stories for the given software based at least in part on processing the at least one knowledge graph using at least one LLM. More particularly, one or more embodiments can include extracting element information and/or relationship information from the at least one knowledge graph to generate and/or modify at least one prompt template for the at least one LLM (e.g., generative pre-trained transformers (GPTs), bidirectional encoder representations from transformers (BERT), etc.) to generate the one or more user stories. Further, in at least one embodiment, feedback on the one or more generated user stories can be obtained (e.g., from one or more users (such as development team personnel, etc.) and used to refine at least a portion of the one or more user stories before outputting the one or more user stories for use in connection with development of the given software.

Accordingly, at least one embodiment includes providing beneficial effects such as, for example, generating and/or implementing an automated user story generation system that enhances the quality of user stories, reduces the time and resources required to generate user stories, accelerates agile development processes, and improves software development outputs with respect to user needs and/or requirements.

FIG. 1 is a diagram illustrating example system architecture for automatically generating software functionality descriptions, according to an example embodiment of the invention. By way of illustration, FIG. 1 depicts automated software functionality description generation system 105, which includes architecture graph parser 104 and user story generator 116. Accordingly, one or more embodiments include automatically generating a user story 112 based at least in part on a functional architecture graph (e.g., user story knowledge graph 106) and at least one LLM 122. More particularly, architecture graph parser 104 parses the elements and relationships within functional architecture graphs 114 based at least in part on processing image features and at least one original XML file associated with functional architecture graphs 114.

Additionally, as depicted in FIG. 1, user story knowledge graph 106 is generated and/or output by architecture graph parser 104 and/or based on the outputs of architecture graph parser 104. In one or more embodiments, user story knowledge graph 106 represents and/or stores at least a portion of the elements and relationships via an architecture graph. Additionally or alternatively, one or more embodiments can include aligning different descriptions from the different functional architecture graphs 114 and building user story knowledge graph 106 for one or more whole functions.

Further, user story knowledge graph 106 and/or information therefrom is provided to user story generator 116. In addition to the user story knowledge graph 106 and/or information therefrom, user story generator 116 processes information pertaining to one or more software-related requirements 108, information from at least one related knowledge base 110, and input from user 102. Based at least in part on such processing, user story generator 116 generates and outputs user story 112. More particularly, within user story generator 116, artificial intelligence agent 118 processes at least a portion of the noted inputs to generate and/or modify prompt template 120, which can then be processed by LLM 122 to generate the user story 112 (which can be fine-tuned with feedback processed via artificial intelligence agent 118). The user story 112 can then be output and/or transmitted to user 102 (e.g., a software development-related engineer).

As used herein, an artificial intelligence agent (e.g., artificial intelligence agent 118) refers to refers to a system or program that is capable of autonomously performing one or more tasks on behalf of at least one user and/or system by designing one or more corresponding workflows and utilizing one or more available tools. Also, in at least one embodiment, artificial intelligence agent 118 does not possess and/or maintain the full knowledge base needed for executing all tasks relevant to the agent's design. Accordingly, as noted above, artificial intelligence agent 118, which can represent a learning artificial intelligence agent, can utilize available tools such as, e.g., relevant requirements data (e.g., requirements 108), at least one related knowledge base 110, and at least one user story knowledge graph 106. Once missing information is retrieved from one or more such tools, the artificial intelligence agent 118 can update its own agent knowledge base 123, which can then be used to reassesses a plan of action and/or self-correct one or more aspects of a given task.

In at least one embodiment, artificial intelligence agent 118 includes LLM 122 for natural language processing, and a prompt generator 121 that leverages prompt template 120 to construct tailored prompts based at least in part on information stored in agent knowledge base 123, and also based at least in part on guidance and/knowledge from user story knowledge graph 106, related knowledge base 110, and requirements 108. More particularly, in such an embodiment, prompt generator 121 includes a generative machine learning model which has been trained (e.g., via supervised training) to generate prompts. Further, in one or more embodiments, artificial intelligence agent 118 can generate one or more structured prompts (via prompt generator 121), and process the one or more structured prompts using LLM 122 to create user story 112, ensuring contextual relevance by referencing elements and relationships in the knowledge graph, as well as ensuring intent recognition and validating outputs for coherence.

Further, by way merely of illustration, an example embodiment can include implementing the following workflow in connection with artificial intelligence agent 118. Using inputs from the user story knowledge graph 106, related knowledge base 110, and/or one or more related requirements 108, the artificial intelligence agent 118 leverages prompt template 120 and prompt generator 121 to generate a prompt. The artificial intelligence agent 118 then calls the LLM 122 with the prompt, with portions of the prompt informing the LLM 122 what the task is (e.g., to generate a user story), and what types of tools are available for use (e.g., user story knowledge graph 106, related knowledge base 110, and/or one or more related requirements 108), and also enables the LLM 122 to make the decision on which tool(s) to use as well as the relevant parameters for calling the tool(s). By way of example, prompt template 120 can include variables such as tools_related_prompt, which provides a description of the list of tools available. For each such tool, the prompt template 120 can include the tool name, a description of the tool, one or more required parameters of the tool, and a description of each parameter of the tool. Further, prompt template 120 can include variables such as action_result, which represents and/or indicates the output of the tool(s) noted above.

Based on such a decision from the LLM 122, artificial intelligence agent 118 executes interaction with the given tool(s), obtains the results and/or information from the given tool(s), and add such results to prompt to call the LLM 122 again. One or more embodiments can include iterating the above steps until the decision of the LLM 122 is deemed a final answer, indicating that the process can be finished.

In such a process, the artificial intelligence agent 118 learns to adapt to user expectations over time (e.g., via feedback to the generated user story 112 from user 102). The artificial intelligence agent 118 stores such feedback and related information pertaining to past interactions in agent knowledge base 123, and subsequently uses such stored data to plan future actions and facilitate a customized experience and/or comprehensive response.

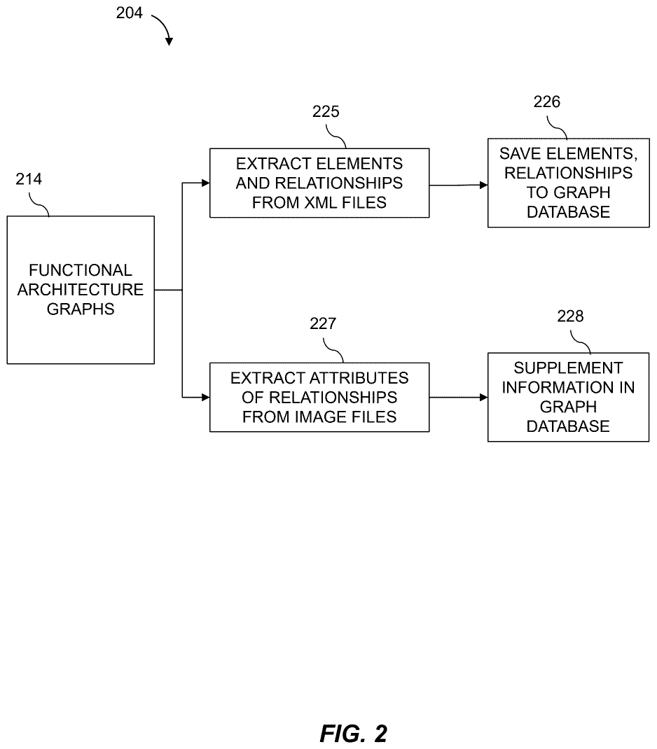

FIG. 2 is a diagram illustrating an example architecture graph parser workflow, according to an example embodiment of the invention. By way of illustration, FIG. 2 depicts a workflow carried out by an example architecture graph parser 204 processing files associated with functional architecture graphs 214 to construct a user story knowledge graph. More particularly, step 225 includes extracting elements and relationships from one or more XML files associated with functional architecture graphs 214. In one or more embodiments, the corresponding XML file(s) can be exported directly through architecture software. Also, step 226 includes saving the extracted element and relationship information to at least one graph database.

While XML files can contain significant element information and attribute relationship information, certain node attribute relationships may be absent, potentially leading to information loss in the generated graph. Accordingly, step 227 includes extracting supplementary information related to attributes of one or more relationships using optical character recognition (OCR) from one or more image files associated with functional architecture graphs 214. Also, step 228 includes supplementing the information stored in the at least one graph database (e.g., the extracted element and relationship information from step 225) with the attribute information extracted in step 227. For example, node attributes can be supplemented according to positional relationship information.

Referring again to step 227, in one or more embodiments, at least a portion of functional architecture graphs 214 can be converted into at least one image file, which can preserve nodes and relationships. Additionally, such an embodiment can include employing OCR technology to analyze the image content and parse the embedded node information for attribute relationships absent from the step 225 analysis. Additionally, based at least in part on the outputs of step 226 and 228, at least one embodiment includes generating a complete architecture graph.

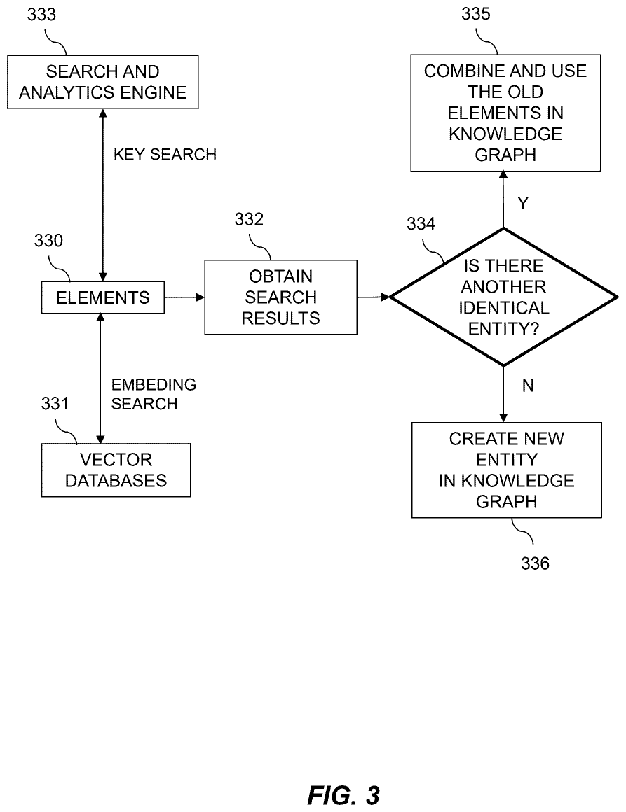

FIG. 3 is a diagram illustrating an example workflow for aligning different entity descriptions as part of building a user story knowledge graph, according to an example embodiment of the invention. By way of illustration, FIG. 3 depicts one or more elements 330, which are used to perform an embedding search in connection with one or more vector databases 331 using one or more embedding models, as well as to perform a key search by using an analytics engine 333. In such an embodiment, an embedding search involves converting text data into dense vector representations using models such as, e.g., sentence transformers, allowing for semantic similarity measurements (e.g., cosine similarity) to retrieve contextually relevant elements from the user story knowledge graph efficiently. Additionally, in such an embodiment, a key search utilizes unique identifiers assigned to each graph element for direct lookups, enabling efficient access to specific components and their attributes. With respect to architecture graphs, many architects will use the same name for the same objects, and in such scenarios, key searching is effective. In order to avoid typographical errors and/or other modifications, one or more embodiments also include composing one or more embedding models to perform an embedding search.

As also depicted in FIG. 3, step 332 includes obtaining search results from the embedding search and the key search. Step 334 then includes determining whether there is another same/identical entity. If yes, then step 335 includes combining and using the old elements in the user story knowledge graph. If no, then step 336 includes creating a new entity in the user story knowledge graph.

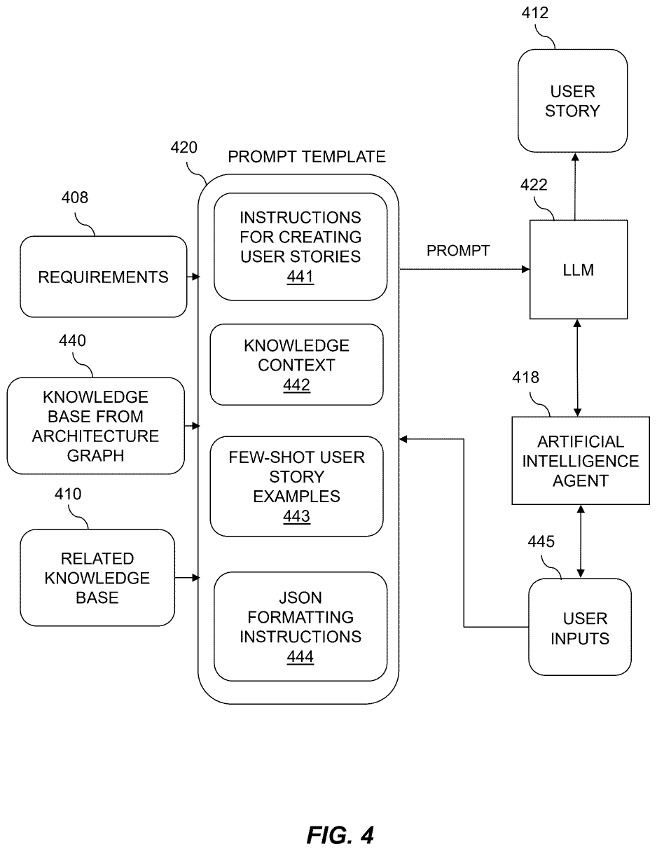

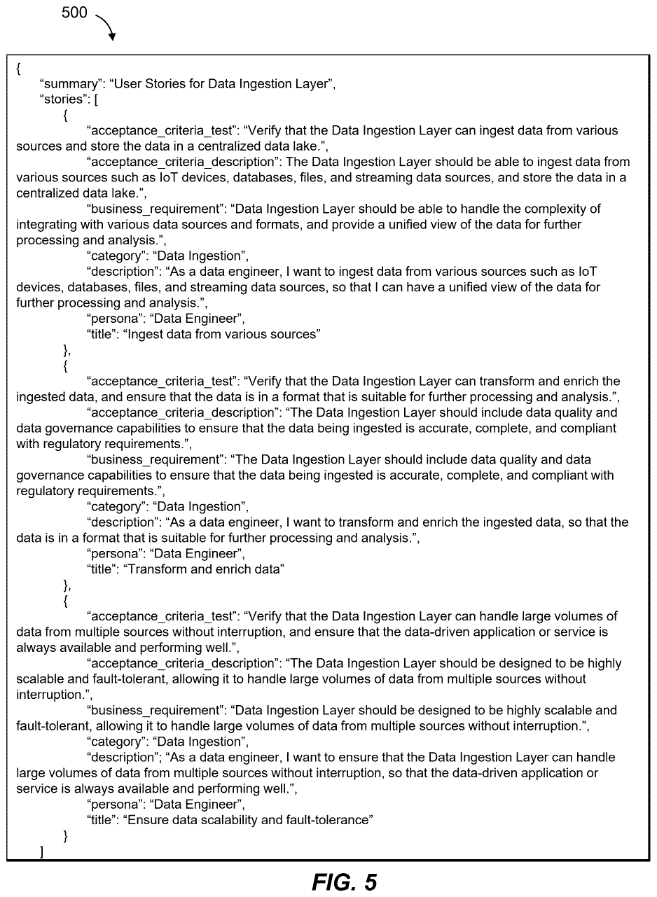

FIG. 4 is a diagram illustrating an example workflow for generating a user story, according to an example embodiment of the invention. By way of illustration, FIG. 4 depicts generating and/or modifying prompt template 420 based on inputs including software-related requirements 408, at least one knowledge base from an architecture graph 440, at least one related knowledge base 410, and user inputs 445. Within prompt template 420, at least a portion of the above-noted inputs are used to populate and/or modify instructions for creating user stories 441, knowledge context 442, few-shot user story examples 443 (such as further detailed, e.g., in connection with FIG. 5), and JSON formatting instructions 444. Based at least in part on such content, a prompt is generated and output to LLM 422, which processes the prompt to output a user story 412 in JSON format. LLM 422 can also update and/or fine-tune the user story 412 based at least in part on feedback from artificial intelligence agent 418, which can base the feedback at least in part on its processing of user inputs 445.

FIG. 5 shows example pseudocode for generating a user story prompt template in an illustrative embodiment. In this embodiment, example pseudocode 500 is executed by or under the control of at least one processing system and/or device. For example, the example pseudocode 500 may be viewed as comprising a portion of a software implementation of at least part of automated software functionality description generation system 105 of the FIG. 1 embodiment.

The example pseudocode 500 illustrates an example user story prompt template generation sequence based on specific architecture with particular components and data flow details. Such an example user story prompt template includes and/or follows the following rules: each story should have a story title, a category, a description, a business requirement, a persona, an acceptance criteria description, and an acceptance criteria test; each story should be formatted as a JavaScript object notation (JSON) document and have a different story title; and each story category should satisfy the user's requirement(s) considering the architecture. Accordingly, an example output of such a user story prompt template is depicted in example pseudocode 500.

It is to be appreciated that this particular example pseudocode shows just one example implementation of generating a user story prompt template, and alternative implementations which include other or alternative content and follows other or alternative rules can be used in other embodiments.

As used in connection with one or more embodiments and further detailed herein, LLMs represent a category of foundation models, which are types of artificial intelligence systems that are trained on a broad set of unlabeled data that can be used for different tasks, with minimal fine-tuning. The unlabeled data includes in some instances imagery and/or language. In response to a prompt being input into the foundation model, the system generates an output such as, e.g., an entire essay or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, e.g., and without too much effort, the human can learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if one wanted to build an artificial intelligence model that could summarize bodies of text, tens of thousands of labeled examples would be needed just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data (e.g., a thousand labeled examples), a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using, e.g., as little as a few thousand sentences (approximately 100 times fewer annotations required than previous models). Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

As noted above, LLMs are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these artificial intelligence systems.

LLMs can be implemented to drive multiple use cases and applications, as well as resolve a multitude of tasks. This LLM concept is in stark contrast to the idea of building and training domain specific models for each of these use cases individually, which is prohibitive under many criteria (e.g., cost and infrastructure), stifles synergies and can even lead to inferior performance.

LLMs represent a significant breakthrough in NLP and artificial intelligence. LLMs are accessible through interfaces such as, e.g., various GPTs and/or BERT models. As such, LLMs are designed to understand and generate text like a human, in addition to other forms of content, based on the vast amount of data used to train the models. LLMs have the ability to infer from context, generate coherent and contextually relevant responses, translate to various languages, summarize text, answer questions and assist in creative writing and/or code generation tasks. LLMs are able to do some or all of these tasks thanks to many (e.g., billions) parameters that enable the models to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. Also, LLMs can include multiple layers of neural networks, each with parameters that can be fine-tuned during training, which are enhanced further by a layer known as an attention mechanism, which dials in on specific parts of datasets.

During the training process, these models learn to predict the next word in a sentence based on the context provided by the preceding words. The model does this through attributing a probability score to the recurrence of words that have been tokenized (i.e., broken down into smaller sequences of characters). These tokens are then transformed into embeddings, which are numeric representations of this context.

To ensure accuracy, this process involves training the LLM on a massive corpora of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove biases, designated language and factually incorrect answers known as “hallucinations” that are often unwanted byproducts of training on so much unstructured data. LLMs augment conversational artificial intelligence in chatbots and virtual assistants to enhance the interactions that provide context-aware responses that mimic interactions with human agents.

LLMs also excel in content generation, automating content creation for articles, explanatory materials, and other writing tasks. LLMs aid in summarizing and extracting information from datasets, accelerating knowledge discovery. LLMs also play a vital role in language translation, breaking down language barriers by providing accurate and contextually relevant translations. LLMs can even be used to write code, or “translate” between programming languages. Also, LLMs contribute to accessibility by assisting individuals with disabilities, including text-to-speech applications and generating content in accessible formats. Further, LLMs can be used to perform sentiment analysis, which includes analyzing text to determine a user's tone in order to understand user feedback at scale and aid in one or more related tasks (e.g., brand reputation management).

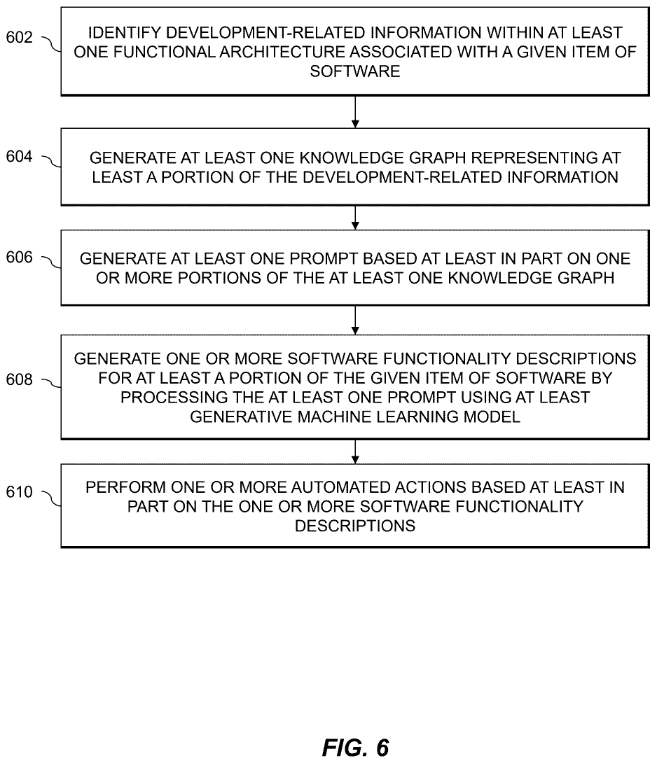

FIG. 6 is a flow diagram illustrating techniques according to an embodiment of the present invention. Step 602 includes identifying development-related information within at least one functional architecture associated with a given item of software. In at least one embodiment, identifying development-related information within at least one functional architecture associated with a given item of software includes parsing information pertaining to one or more elements and one or more relationships within the at least one functional architecture. Additionally or alternatively, identifying development-related information within at least one functional architecture associated with a given item of software can include processing one or more extensible markup language files associated with the at least one functional architecture and/or processing one or more image features associated with the at least one functional architecture.

Step 604 includes generating at least one knowledge graph representing at least a portion of the development-related information. In one or more embodiments, generating at least one knowledge graph includes aligning two or more different descriptions of the at least a portion of the development-related information.

Step 606 includes generating at least one prompt based at least in part on one or more portions of the at least one knowledge graph. In at least one embodiment, generating at least one prompt includes generating, based at least in part on the one or more portions of the at least one knowledge graph, one or more software-development-related requirements, one or more instructions for generating the one or more software functionality descriptions, and one or more formatting instructions.

Step 608 includes generating one or more software functionality descriptions for at least a portion of the given item of software by processing the at least one prompt using at least one generative machine learning model (e.g., at least one LLM). In one or more embodiments, generating one or more software functionality descriptions for at least a portion of the given item of software includes generating a first software functionality description, processing feedback related to the first software functionality description from at least one artificial intelligence agent, and generating a second software functionality description by modifying at least a portion of the first software functionality description based at least in part on one or more portions of the feedback.

Step 610 includes performing one or more automated actions based at least in part on the one or more software functionality descriptions. In at least one embodiment, performing one or more automated actions includes automatically initiating one or more software development tasks for the given item of software based at least in part on the one or more software functionality descriptions. Additionally or alternatively, performing one or more automated actions can include automatically training at least a portion of the at least one LLM using feedback related to the one or more software functionality descriptions. Also, in at least one embodiment, performing one or more automated actions includes automatically transmitting the one or more software functionality descriptions to one or more of at least one software-development-related system and one or more software-development-related users.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented software descriptions for one or more software development implementations. Additionally, such software descriptions can be used to initiate one or more automated actions (e.g., automatically initiating one or more software development tasks, automatically retraining a LLM which generated the software descriptions, automatically transmitting the software descriptions to one or more systems and/or users, etc.).

The techniques depicted in FIG. 6 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 6 can be implemented via a computer program product that can include computer useable program code that is stored in a computer-readable storage medium in a data processing system, and wherein the computer useable program code was downloaded over a network from a remote data processing system. Also, in an embodiment of the invention, the computer program product can include computer useable program code that is stored in a computer-readable storage medium in a server data processing system, and wherein the computer useable program code is downloaded over a network to a remote data processing system for use in a computer-readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as LLM-based software description generation code 726. In addition to LLM-based software description generation code 726, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and LLM-based software description generation code 726, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

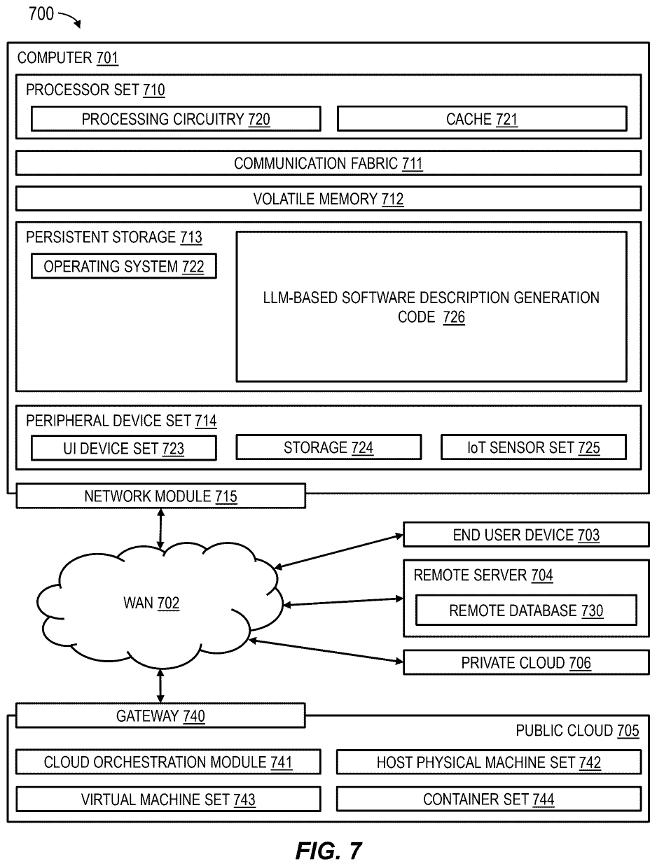

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer-readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in LLM-based software description generation code 726 in persistent storage 713.

Communication fabric 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type RAM or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a ROM, but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in LLM-based software description generation code 726 typically includes at least some of the computer code involved in performing the inventive methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer-readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

In computing environment 700, computer 701 is shown as being connected to the internet (see WAN 702). However, in many embodiments of the present invention computer 701 will be isolated from communicating over communications network and not connected to the internet, running as a standalone computer. In these embodiments, network module 715 of computer 701 may not be necessary or even desirable in order to ensure isolation and to prevent external communications coming into computer 701. The standalone computer embodiments are potentially advantageous, at least in some applications of the present invention, because they are typically more secure. In other embodiments, computer 701 is connected to a secure WAN or a secure LAN instead of WAN 702 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying development-related information within at least one functional architecture associated with a given item of software;
generating at least one knowledge graph representing at least a portion of the development-related information;
generating at least one prompt based at least in part on one or more portions of the at least one knowledge graph;
generating one or more software functionality descriptions for at least a portion of the given item of software by processing the at least one prompt using at least one generative machine learning model; and
performing one or more automated actions based at least in part on the one or more software functionality descriptions.

2. The computer-implemented method of claim 1, wherein identifying development-related information within at least one functional architecture associated with a given item of software comprises parsing information pertaining to one or more elements and one or more relationships within the at least one functional architecture.

3. The computer-implemented method of claim 1, wherein identifying development-related information within at least one functional architecture associated with a given item of software comprises processing one or more extensible markup language files associated with the at least one functional architecture.

4. The computer-implemented method of claim 1, wherein identifying development-related information within at least one functional architecture associated with a given item of software comprises processing one or more image features associated with the at least one functional architecture.

5. The computer-implemented method of claim 1, wherein performing one or more automated actions comprises automatically initiating one or more software development tasks for the given item of software based at least in part on the one or more software functionality descriptions.

6. The computer-implemented method of claim 1, wherein generating at least one knowledge graph comprises aligning two or more different descriptions of the at least a portion of the development-related information.

7. The computer-implemented method of claim 1, wherein generating at least one prompt comprises generating, based at least in part on the one or more portions of the at least one knowledge graph, one or more software-development-related requirements, one or more instructions for generating the one or more software functionality descriptions, and one or more formatting instructions.

8. The computer-implemented method of claim 1, wherein generating one or more software functionality descriptions for at least a portion of the given item of software comprises generating a first software functionality description, processing feedback related to the first software functionality description from at least one artificial intelligence agent, and generating a second software functionality description by modifying at least a portion of the first software functionality description based at least in part on one or more portions of the feedback.

9. The computer-implemented method of claim 1, wherein performing one or more automated actions comprises automatically training at least a portion of the at least one generative machine learning model using feedback related to the one or more software functionality descriptions.

10. The computer-implemented method of claim 1, wherein performing one or more automated actions comprises automatically transmitting the one or more software functionality descriptions to one or more of at least one software-development-related system and one or more software-development-related users.

11. A computer program product comprising:
one or more computer-readable storage media; and
program instructions stored on the one or more computer-readable storage media to perform operations comprising:
identifying development-related information within at least one functional architecture associated with a given item of software;
generating at least one knowledge graph representing at least a portion of the development-related information;
generating at least one prompt based at least in part on one or more portions of the at least one knowledge graph;
generating one or more software functionality descriptions for at least a portion of the given item of software by processing the at least one prompt using at least one generative machine learning model; and
performing one or more automated actions based at least in part on the one or more software functionality descriptions.

12. The computer program product of claim 11, wherein identifying development-related information within at least one functional architecture associated with a given item of software comprises parsing information pertaining to one or more elements and one or more relationships within the at least one functional architecture.

13. The computer program product of claim 11, wherein identifying development-related information within at least one functional architecture associated with a given item of software comprises processing one or more extensible markup language files associated with the at least one functional architecture.

14. The computer program product of claim 11, wherein identifying development-related information within at least one functional architecture associated with a given item of software comprises processing one or more image features associated with the at least one functional architecture.

15. The computer program product of claim 11, wherein performing one or more automated actions comprises automatically initiating one or more software development tasks for the given item of software based at least in part on the one or more software functionality descriptions.

16. A computer system comprising:
a processor set;
one or more computer-readable storage media; and
program instructions stored on the one or more computer-readable storage media to cause the processor set to perform operations comprising:
identifying development-related information within at least one functional architecture associated with a given item of software;
generating at least one knowledge graph representing at least a portion of the development-related information;
generating at least one prompt based at least in part on one or more portions of the at least one knowledge graph;
generating one or more software functionality descriptions for at least a portion of the given item of software by processing the at least one prompt using at least one generative machine learning model; and
performing one or more automated actions based at least in part on the one or more software functionality descriptions.

17. The computer system of claim 16, wherein identifying development-related information within at least one functional architecture associated with a given item of software comprises parsing information pertaining to one or more elements and one or more relationships within the at least one functional architecture.

18. The computer system of claim 16, wherein identifying development-related information within at least one functional architecture associated with a given item of software comprises processing one or more extensible markup language files associated with the at least one functional architecture.

19. The computer system of claim 16, wherein identifying development-related information within at least one functional architecture associated with a given item of software comprises processing one or more image features associated with the at least one functional architecture.

20. The computer system of claim 16, wherein performing one or more automated actions comprises automatically initiating one or more software development tasks for the given item of software based at least in part on the one or more software functionality descriptions.
